(19) United States
(12) Patent Application Publication
(10) Pub. No.: US 2004/0165889 A1
(43) Pub. Date: Aug. 26, 2004

(54) Hybrid fiber to the home/fiber to the curb telecommunications apparatus and methods

(76) Inventors: Glenn Mahony, Duluth, GA (US); David W. Levenson, Duluth, GA (US)

Correspondence Address: MYERS BIGEL SIBLEY & SAJOVEC, PO BOX 37428, RALEIGH, NC, 27627, US

(21) Appl. No.: 10/606,677

(22) Filed: Jun. 27, 2003

Related U.S. Application Data
(60) Provisional application No. 60/449,999, filed on Feb. 25, 2003.

(51) Int. Cl. H04J 14/00

(52) U.S. Cl. 398/71

(57) ABSTRACT

A telecommunications system includes a passive optical network (PON) including an optical splitter configured to serve optical network terminations (ONTs) at respective ones of a plurality of subscriber premises. The system further includes an optical network unit (ONU) coupled to the PON and configured to provide communications for the plurality of the subscriber premises. The optical splitter may directly subtend the ONU, and the optical splitter and the ONU may be co-located, for example, at the same pole or pedestal. The ONU may be powered by a power source located at a remote terminal (RT). A composite fiber/conductor cable may couple an optical line terminal (OLT), which may be positioned at a central office (CO) or the RT, and the power source to the optical splitter and the ONU, respectively.

### RELATED APPLICATION

The present application claims the benefit of U.S. Provisional Application Serial No. 60/449,999, entitled Hybrid Fiber to the Curb/Fiber to the Home Architecture, filed Feb. 25, 2003, the content of which is hereby incorporated by reference in its entirety.

### BACKGROUND OF THE INVENTION

Two fiber distribution architectures have been traditionally deployed in the past. The first is Fiber to the Curb (FTTC). In this architecture, fiber is placed to an electronics point at a curbside pedestal or pole. The electronics at the curb convert the optical signals to electrical signals to provide voice, data, and video services from the curb over traditional copper and/or coax drops. The electronics at the curb is powered via the telephony network and thus provides continuous telephone service during a power outage. This approach has been proven to be economical to deploy but contains bandwidth limitations from the curb to the house (drops). In addition, when capability for a particular service is provided, the electronics upgrade includes the capability and associated cost to generally service multiple customers.

A second approach is Fiber to the Home (FTTH). The architecture provides fiber facilities to the customer's home with no electronics at the curb. This architecture can provide broadband capability to the customer's home but can be very expensive to deploy. It also typically requires the customer to power the home electronics and, thus, can result in lower reliability for telephony services. Examples of FTTH systems are described in U.S. Pat. No. 6,427,035 to Mahony, assigned to the assignee of the present invention.

### SUMMARY OF THE INVENTION

According to some embodiments of the present invention, a telecommunications system includes a passive optical network (PON) including an optical splitter configured to serve optical network terminations (ONTs) at respective ones of a plurality of subscriber premises. The system further includes an optical network unit (ONU) coupled to the PON and configured to provide communications for the plurality of the subscriber premises.

According to some embodiments, the optical splitter may directly subtend the ONU, and the optical splitter and the ONU may be co-located, for example, at the same pole or pedestal. The ONU may be powered by a power source located remote from the ONU, e.g., at a remote terminal (RT). A composite fiber/conductor cable may couple an optical line terminal (OLT), which may be positioned at a central office (CO) or the RT, and the power source to the optical splitter and the ONU, respectively.

In further embodiments of the present invention, the optical splitter interfaces a first optical fiber to a plurality of second optical fiber, and one of the second optical fibers directly connects the optical splitter to the ONU. In some embodiments, at least one of the second optical fibers serves a subscriber premises of the plurality of subscriber premises. For example, at least one of the second optical fibers directly connects the optical splitter to an ONT at a subscriber premises. In further embodiments, at least one of the second optical fibers may serve a second optical splitter and/or a second ONU.

In still further embodiments, the optical splitter and the ONU are positioned at a pedestal. At least one of the second optical fibers may include a buried fiber optic drop extending from the pedestal to an ONT at a subscriber premises. A buried composite cable may carry at least one of the second optical fibers and at least one conductor from the ONU to a service drop location, and the system may further include a second optical splitter at the service drop location that interfaces the at least one of the second optical fibers to at least one fiber optic drop connected to an ONT at a subscriber premises, and at least one conductor drop extending from the service drop location to the subscriber premises.

In some embodiments, the optical splitter and the ONU may be positioned at a pedestal on a first side of a street. At least one of the second optical fibers and at least one conductor connected to the ONU serve subscriber premises on the first side of the street. A buried composite cable carries at least one of the second optical fibers and at least one conductor connected to the ONU to a location on a second side of the street to serve subscriber premises on the second side of the street.

In exemplary aerial deployment embodiments, the optical splitter and the ONU are positioned at a pole. At least one of the second optical fibers includes an aerial fiber optic drop extending from the pole to an ONT at a subscriber premises. An aerial composite cable may carry at least one of the second optical fibers and at least one conductor from the ONU to a second pole. The system may further include a second optical splitter that is positioned at the second pole and that interfaces the at least one of the second optical fibers to at least one aerial fiber optic drop connected to an ONT at a subscriber premises, and at least one aerial conductor drop extending from the second pole to the subscriber premises.

In still further embodiments, at least one of the second optical fibers and at least one conductor connected to the ONU serve subscriber premises on the first side of the street. An aerial composite cable carries at least one of the second optical fibers and at least one conductor connected to the ONU to a second pole on the first side of the street. The system further includes a second optical splitter that is positioned at the second pole and that interfaces the at least one of the second optical fibers to aerial fiber optic drops to ONTs located at respective subscriber premises on the first side of the street and a second side of the street. A plurality of aerial conductor drops extends from the second pole to the subscriber premises on the first and second sides of the street.

According to other aspects of the present invention, a telecommunications apparatus includes an optical splitter configured to interface a first fiber of a PON to a plurality of second fibers, and an ONU co-located with the optical splitter, connected to one of the second optical fibers and configured to interface a plurality of conductive circuits to the one of the second fibers. The optical splitter and the ONU may be configured to be co-located at one of a pole or a pedestal. The optical splitter and the ONU may be respectively configured to receive the first fiber and a power conductor from a composite cable.

According to some method embodiments of the present invention, ONTs located at respective ones of a plurality of subscriber premises are served by an optical splitter of a hierarchical passive optical network (PON). Electrical (e.g., via twisted pair or other electrical media) communications for the plurality of subscriber premises are provided by an optical network unit (ONU) coupled to the PON.

### BRIEF DESCRIPTION OF THE DRAWINGS

FIG. 1 is a schematic diagram illustrating a telecommunications system according to some embodiments of the present invention.

FIG. 2 is a schematic diagram illustrating an exemplary FTTH/FTTC architecture according to some embodiments of the present invention.

FIG. 3 is a schematic diagram illustrating an exemplary FTTH/FTTC architecture according to other embodiments of the present invention.

FIG. 4 is a schematic diagram illustrating an exemplary FTTH/FTTC architecture for video services according to some embodiments of the present invention.

FIG. 5 is a schematic diagram illustrating an FTTH/FTTC architecture for buried deployment according to some embodiments of the present invention.

FIG. 6 is a schematic diagram illustrating an exemplary FTTC/FTTH buried deployment according to further embodiments of the present invention.

FIG. 7 is a schematic diagram illustrating an FTTH/FTTC reference architecture for aerial deployment according to some embodiments of the present invention.

FIG. 8 is a schematic diagram illustrating an exemplary FTTH/FTTC aerial deployment according to further embodiments of the present invention.

### DETAILED DESCRIPTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present.

Some embodiments of this invention can provide a distribution architecture that allows for an economical deployment of a broadband network. The architecture can provide a more economical solution than traditional Fiber to the Home architectures while still providing broadband services (telephony, data, and video). Some embodiments of the invention can be used by various broadband network providers to deploy fiber distribution in residential areas.

Embodiments of the invention can provide a broadband architecture that can provide more bandwidth to the home than traditional FTTC and that can be more economical than traditional FTTH. Embodiments of the invention can also provide for network powering of telephony services and thus, the substantially similar levels of reliability as provided today. Hybrid architectures according to some embodiments of the invention can allow home units to be placed only at customers who request broadband services.

A hybrid architecture according to some embodiments of the invention includes the deployment of fiber optic cable from a Central Office into a distribution area and, potentially, all the way to the customer's location, depending on the service requirements. The architecture may include a Passive Optical Network (PON) architecture, originating in the Central Office or remote terminal (RT) location depending on the loop length. The PON electronics may utilize ATM requirements (i.e. ITU G.983.1-G983.3 recommendations) and/or other protocol requirements as they become available (i.e. IEEE). The architecture may include remote electronics to be located in two locations:

1. A first set of electronics that can be housed in a pedestal enclosure generally located at the curb and commonly referred to as an Optical Network Unit (ONU). These enclosures can serve multiple homes via drops and typically support telephony and/or data services. Pedestal electronics can be powered via copper cables from a centralized powering location (i.e. Power node or RT).

2. Electronics placed at the customer location to provide higher bandwidth services such as data and/or video. The home electronics, generally referred to as Optical Network Terminations (ONTs), may be housed in an enclosure mounted at the customer house. These ONT electronics may be customer powered.

The architecture may include a base architecture of a single fiber point-to-multipoint passive optical network (PON) utilizing ATM (outlined in ITU Recommendations G.983.1- G.983.3) and/or Ethernet (IEEE 802.3ah—currently in draft status) protocols. The PON system may operate at 1310 nm upstream and 1490 nm downstream. A 1550 nm “enhancement band” downstream may be used for video services and may use the data network for video services upstream. The Optical Line Termination (OLT) can be located in the Central Office, but can also be located in the field if housing and powering costs are lower than PON fiber feeder costs, e.g. longer loops. The ONT may be located at customer premises and may be powered from the customer premises. The ONT may be located within 1,000 feet of customer premises. Voice or voice and data services may be provided from the ONU using a twisted pair drop. Video service may be provided from the ONT. Data service may be provided from either the ONT or the ONU. The curb electronics can provide sharing of the electronics with network powering and the home electronics can allow for broadband capability at the home with electronics required only when broadband services are required.

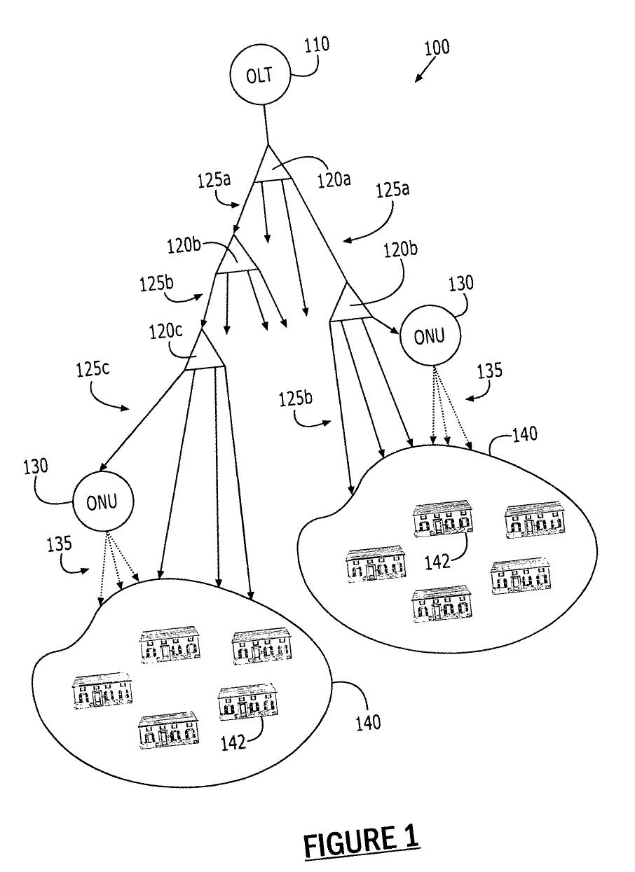

FIG. 1 illustrates a telecommunications system 100 according to some embodiments of the present invention. The system 100 includes a passive optical network (PON) emanating from an optical line terminal (OLT) 110 further includes a plurality of optical splitters 120a, 120b, 120c and optical fibers 125a, 125b, 125c. The system 100 further includes one or more optical network units (ONUs) 130 connected to conductor drops 135 that serve respective pluralities or clusters 140 of subscriber premises 142 that are also served by the optical splitters 120b, 120c. As shown, the PON has a hierarchical configuration, e.g., the splitter 120a subtends the splitters 120b, one of the splitters 120b subtends the splitter 120c, one of the splitters 120b subtends an ONU 130 and a plurality 140 of subscriber premises 142 (directly and/or via one or more intervening splitters), and the splitter 120c subtends another ONU 130 and another plurality 140 of subscriber premises 142 (directly and/or via one or more intervening splitters). Although the subscriber premises 142 are illustrated in FIG. 1 as single-family residential premises, it will be appreciated that subscriber premises may also take other forms, including, but not limited to, other types of residential premises, commercial premises and institutional premises.

It will be further appreciated that the present invention is applicable to a variety of different types of passive optical networks, and that various different components may provide the functionality described in FIG. 1, notwithstanding the use of “labels” that are different than those used in describing FIG. 1. For example, for purposes of the present application, “ONT” may be construed as referring to any equipment that provides the user-premises terminal-end functionality described herein, even if that equipment may commonly be referred to using labels other than “ONT.” Similarly, for purposes of the present application, “OLT” may be construed as referring to any type of head-end equipment that provides the functionality of an OLT described herein, and “ONU” may be construed as referring to any type of equipment that provides the optical to electrical conversion functionality described herein.

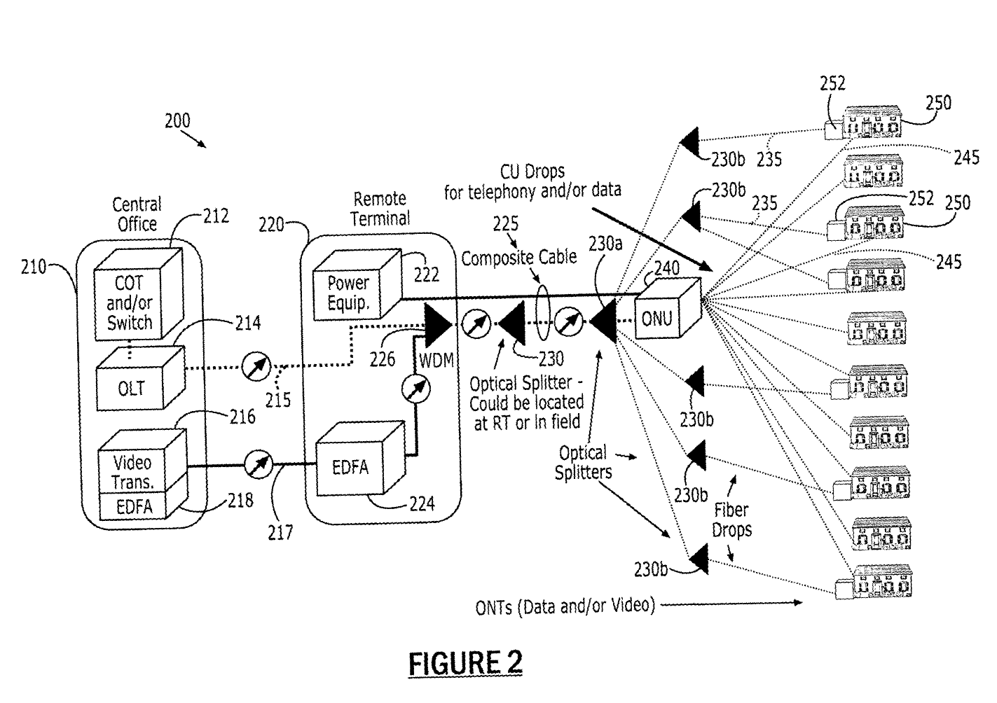

FIG. 2 illustrates an exemplary telecommunications system 200 according to further embodiments of the present invention. The system includes an OLT 214 that is positioned at a central office (CO) 210. As shown, the OLT 214 is in communication with a central office terminal (COT) and/or a telephony switch 212. Detailed signaling operations of the OLT 214 and/or the COT/Switch 212 are known to those skilled in the art and will not be discussed in detail herein. As shown, the CO 210 may also include a video transmitter 216 and a fiber amplifier, here shown as an erbium doped fiber amplifier (EDFA) 218.

Optical fibers 215, 217 link the CO 210 to a remote terminal (RT) 220. The RT 220 includes a second EFDA 224 that receives and amplifies signals from the first EDFA 218 over the fiber 217, and provides the amplified signals to a wave division multiplexer (WDM) 226, which is also coupled to the fiber 215 running from the OLT 214. The WDM 226 is further coupled to a composite fiber/electrical conductor cable 225 that includes electrical conductors for conveying power from a power supply 222 positioned at the RT 220. It will be appreciated that, depending upon the application, the second EDFA 224 may not be needed, such that the first EDFA 218 is directly coupled to the WDM 226.

The composite cable 225 couples the WDM 226 to an optical splitter 230a that serves an ONU 240 and a plurality of optical network terminations (ONTs) 252 located at subscriber premises 250. In particular, the optical splitter 230a may directly serve the ONU 240 and may also serve a plurality of splitters 230b from which fiber optic drops 235 extend to the subscriber premises 250, which are also served by the ONU 240 via conductor (e.g., copper twisted pair) drops 245. As shown, the splitter 230a may be linked to the RT 220 via one or more intervening splitters 230, but it will be appreciated that the splitter 230 may not be present. The ONU 240 receives power for its operation from the power supply 222 at the RT 220 via the composite cable 225, such that the service between the subscriber premises 250 and the ONU 240 may be maintained notwithstanding the status of the power supply to subscriber equipment at the subscriber premises 250. In contrast, power for the ONTs 252 may be provided from the subscriber premises.

This arrangement may be advantageous for some service configurations. For example, as illustrated, the fiber optic drops 235 may be used to provide broadband services, such as data services (e.g., a data service provided via the COT/switch 212) and/or video services (e.g., a video service provided via the video transmitter 216), while the conductor drops 245 may be used to provide narrower band services, such as a telephony service and/or a narrower bandwidth data service (e.g., services provided via the COT/switch 212). In such a configuration, for example, less critical services, such as internet, multimedia, or other broadband services provided by fiber optic drops 235, may use subscriber-powered terminal equipment (thus reducing power requirements for the system operator), while more critical services, such as telephony, may use a more robust power source maintained by the operator. It will be appreciated, however, that other service configurations may be used with the present invention. For example, video service may be omitted, such the video transmitter 216, EDFAs 218, 224 and the WDM 226 may be omitted.

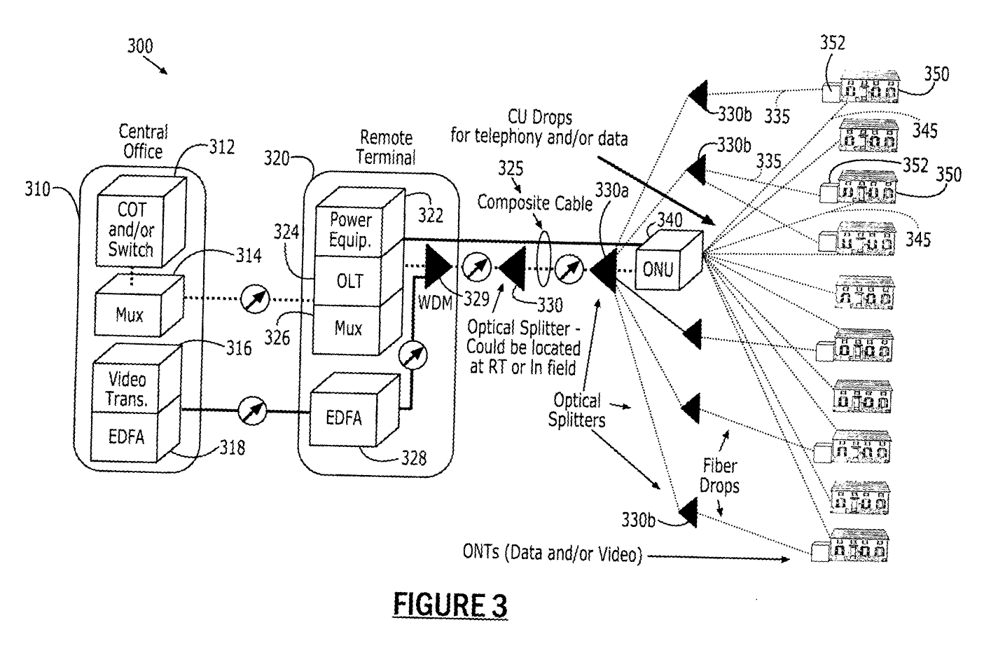

FIG. 3 illustrates a telecommunications system 300 according to further embodiments of the present invention. The system 300 includes a CO 310 including a COT and/or switch 312 and a first multiplexer (mux) 314 coupled to a second mux 326 at an RT 320. The CO further includes a video transmitter 316 and EDFA 318 along the lines described above with reference to corresponding components of FIG. 2. The RT 320 also includes a second EDFA 328, a power supply 322, and a WDM 329, similar to corresponding components shown in the RT 220 of FIG. 2.

The configuration of FIG. 3 differs from that illustrated in FIG. 2 in that, among other things, the RT 320 includes an OLT 324, coupled to a mux 326, that serves as a terminal point of a passive optical network that is coupled to an optical splitter 330a and ONU 340, which serves a plurality of subscriber premises 350 via fiber optic drops 335, ONTs 352 and conductor drops 345 in a manner similar to that described above with reference to FIG. 2. A composite fiber/conductor cable 325 couples the RT 320 to a splitter 330a and an ONU 340 in a manner similar to that described above with reference to FIG. 2, i.e., one or more intervening splitters 330 may be present. The system 300 can, for example, provide video, data and/or telephony services in a manner similar to that described above with reference to FIG. 2. As with the system 200 of FIG. 2, the video overlay may be omitted, i.e., the video transmitter 316, EDFAs 318, 328 and the WDM 329 may be omitted.

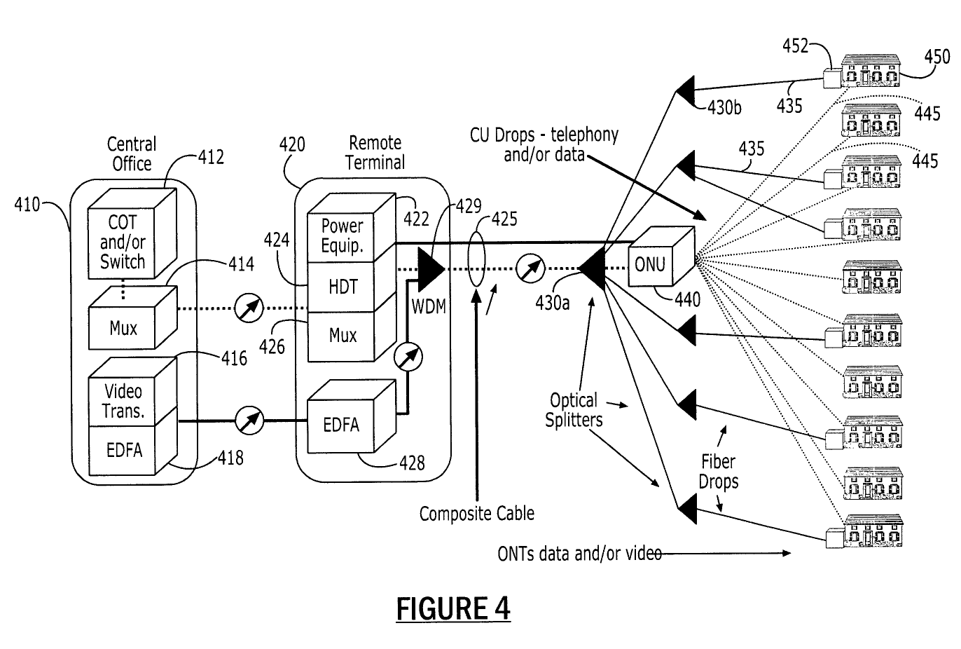

FIG. 4 illustrates a telecommunications system 400 according to still further embodiments of the present invention, in which a host digital terminal (HDT) 424 provides equivalent functionality to the OLTs 214, 324 of FIGS. 2 and 3. The system 400 includes a CO 410 including a COT and/or switch 412 and a first multiplexer (mux) 414 coupled to a second mux 426 at an RT 420. The CO 410 further includes a video transmitter 416 and EDFA 418 along the lines described above with reference to FIGS. 2 and 3. The RT 420 also includes a second EDFA 428, a power supply 422, and a WDM 429, similar to corresponding components shown in the RT 320 of FIG. 3.

The HDT 424, coupled to a mux 426, serves as a head end of a passive optical network that is coupled to an optical splitter 430a and ONU 440, which serves a plurality of subscriber premises 450 via fiber optic drops 435, ONTs 452 and conductor drops 445 in a manner similar to that described above with reference to FIGS. 2 and 3. A composite fiber/conductor cable 425 couples the RT 420 to a splitter 430a and an ONU 440. As shown, this coupling is without an intervening splitter, but it will be appreciated that one or more intervening splitters may be present. As shown, the system 400 is configured to provide telephony and/or data services for the subscriber premises 450 via an ONU 440 and copper drops 445, but provides only video service via the PON, including splitters 430a, 430b and fiber optic drops 435. As with the systems 200, 300 of FIGS. 2 and 3, the video overlay may be omitted, i.e., the video transmitter 416, EDFAs 418, 428 and the WDM 429 may be omitted.

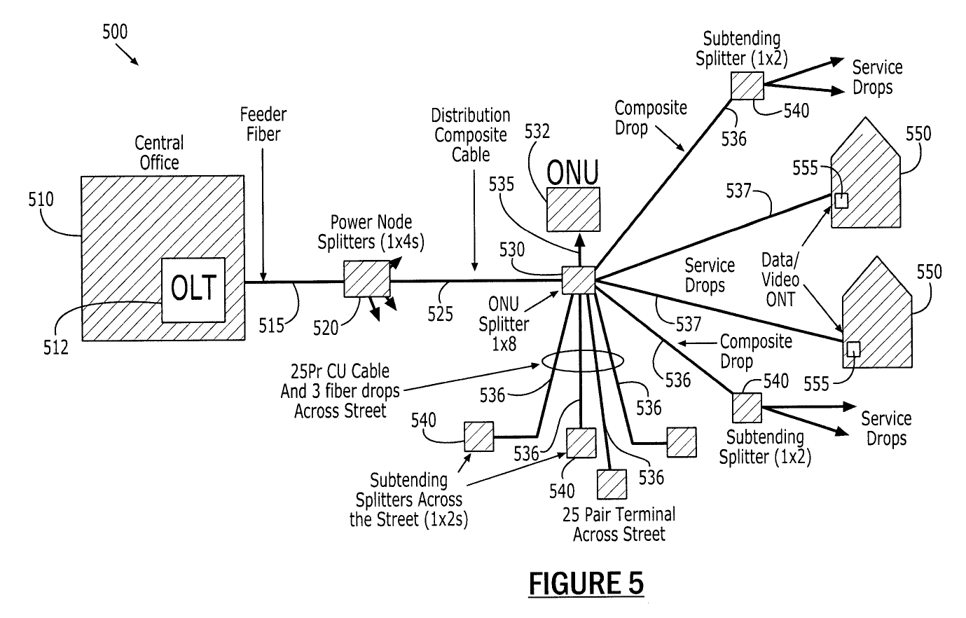

FIG. 5 illustrates an exemplary configuration for a telecommunications system 500 according to some embodiments of the invention, in particular, a system particularly suited to buried deployment. The system 500 includes an OLT 512 at a CO 510. A PON emanates from the OLT 512. The PON includes a power node splitter 520 linked to the CO 510 by a feeder fiber 515, a splitter 530 co-located at a pedestal with an ONU 532 and coupled to the power node splitter 520 by a composite cable 525, and subtending splitters 540 positioned at other pedestals and linked to the ONU-serving splitter 530 by composite drops 536. The ONU-serving splitter 530 also directly serves ONTs 555 at customer premises 550 via fiber optic drops 537, and may serve other premises (not shown), via the composite cables 536 and the subtending splitters 540, on a first side of street. As shown, the splitter 530 serves additional subtending splitters 540 on a second side of the street via fiber and conductor drops 536.

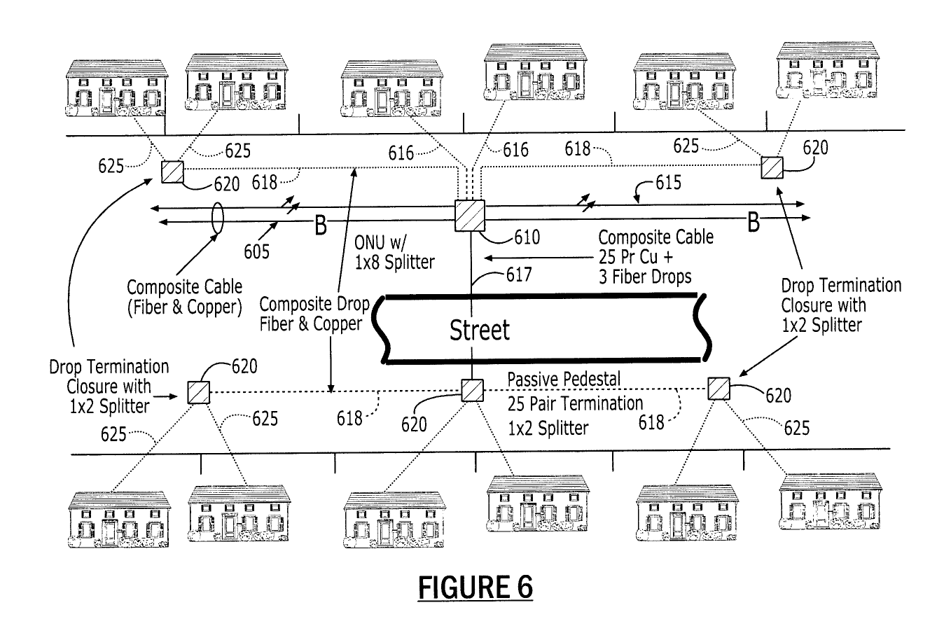

FIG. 6 illustrates an exemplary buried deployment according to further embodiments of the present invention. A combination of a splitter and ONU at a pedestal 610 is fed by a composite cable 605 and is positioned on a first side of a street. A composite cable 617 feeds a splitter at a passive pedestal 620 on a second side of the street. The splitter at the pedestal 610 also subtends other splitters at other passive pedestals 620 on the first side of the street. Fiber optic drops 616 directly extend from the pedestal 610 to some premises, while other premises are fed from the pedestals 620 via drops 625. Another composite cable 615 extends from the pedestal 610, and may be used, for example, to feed another splitter and/or ONU elsewhere in the neighborhood.

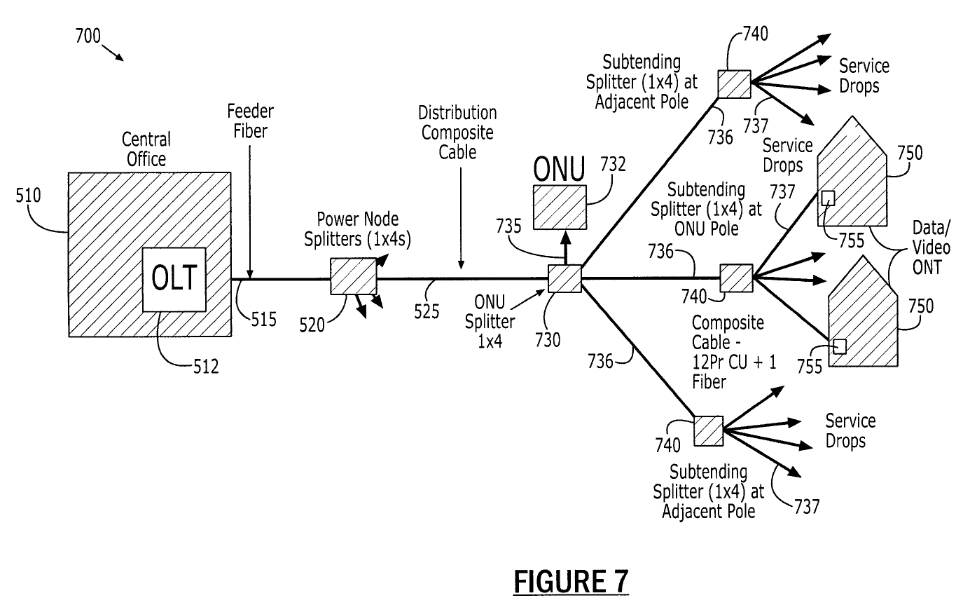

FIG. 7 illustrates an exemplary configuration for a telecommunications system 700 according to some embodiments of the invention, in particular, a system particularly suited to aerial deployment. The system 700 includes an OLT 512 at a CO 510. A PON emanates from the OLT 512. The PON includes a power node splitter 520 linked to the CO 510 by a feeder fiber 515, a splitter 730 co-located at a pole with an ONU 732 and coupled to the power node splitter 520 by a composite cable 525. Subtending splitters 740 are positioned at the same pole and at other poles and linked to the ONU-serving splitter 730 by drops 736. The subtending splitters 740 serve ONTs 755 at subscriber premises via service drops 737.

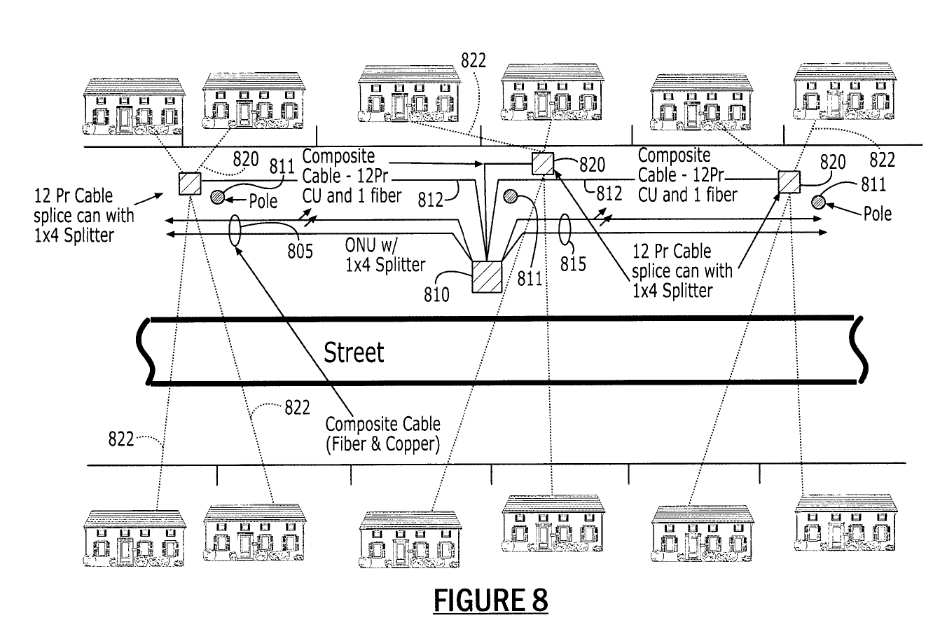

An exemplary aerial deployment according to further embodiments of the present invention is illustrated in FIG. 8. A combination of an ONU and splitter 810 at a pole 811 on a first side of a street is fed by a composite cable 805. The splitter 810 subtends other splitters 820 on the same pole 811 and other poles 811 on the first side of the street via composite cables 812. Composite drops 822 feed premises on the first side of the street and on the second side of the street from the splitters 820. Another composite cable 815 extends from the splitter and ONU 810, and may be used, for example, to feed another splitter and/or ONU elsewhere in the neighborhood.

It will be appreciated the exemplary embodiments of FIGS. 5-8 are offered for purposes of illustration, and that the present invention is not limited to these specific implementations. For example, various types of splitters (e.g., 1×8, 1×4, 1×3) may be used depending, for example, on the physical layout of the premises and/or areas being served, and buried and aerial deployments may be combined for a single PON.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A telecommunications system, comprising:
a passive optical network (PON) including an optical splitter configured to serve optical network terminations (ONTs) at respective ones of a plurality of subscriber premises; and
an optical network unit (ONU) coupled to the PON and configured to provide communications for the plurality of the subscriber premises.

2. A system according to claim 1, wherein the optical splitter directly subtends the ONU.

3. A system according to claim 2, wherein the optical splitter and the ONU are co-located.

4. A system according to claim 3, wherein the optical splitter and the ONU are positioned at a pedestal or pole.

5. A system according to claim 1, wherein the ONU is powered by a power source a location remote from the ONU.

6. A system according to claim 5, wherein a composite copper/fiber cable couples an optical line terminal (OLT) and the power source to the optical splitter and the ONU, respectively.

7. A system according to claim 5, wherein a composite copper/fiber cable couples a host digital terminal (HDT) and the power source to the optical splitter and the ONU, respectively.

8. A system according to claim 1, comprising a plurality of ONUs that provide communications to respective geographical clusters of subscriber premises, and wherein the PON comprises a plurality of optical splitters configured to serve ONTs at respective ones of the geographical clusters of subscriber premises and subtending the respective ONUs.

9. A system according to claim 1:
wherein the optical splitter interfaces a first optical fiber to a plurality of second optical fibers;
wherein one of the second optical fibers directly connects the optical splitter to the ONU; and
wherein at least one of the second optical fibers directly serves a subscriber premises of the plurality of subscriber premises.

10. A system according to claim 9, wherein at least one of the second optical fibers serves a second optical splitter.

11. A system according to claim 9, wherein at least one of the second optical fibers serves a second ONU that provides communications for a second plurality of subscriber premises.

12. A system according to claim 1:
wherein the optical splitter interfaces a first optical fiber to a plurality of second optical fibers;
wherein one of the second optical fibers directly connects the optical splitter to the ONU;
wherein the optical splitter and the ONU are positioned at a pedestal; and
wherein at least one of the second optical fibers comprises a buried fiber optic drop extending from the pedestal to an ONT at a subscriber premises.

13. A system according to claim 1:
wherein the optical splitter interfaces a first optical fiber to a plurality of second optical fibers;
wherein one of the second optical fibers directly connects the optical splitter to the ONU;
wherein the optical splitter and the ONU are positioned at a pedestal;
wherein a buried composite cable carries at least one of the second optical fibers and at least one conductor from the ONU to a service drop location; and
wherein the system further comprises:
a second optical splitter at the service drop location that interfaces the at least one of the second optical fibers to at least one fiber optic drop connected to an ONT at a subscriber premises; and
at least one conductor drop extending from the service drop location to the subscriber premises.

14. A system according to claim 1:
wherein the optical splitter interfaces a first optical fiber to a plurality of second optical fibers;
wherein one of the second optical fibers directly connects the optical splitter to the ONU;
wherein the optical splitter and the ONU are positioned at a pedestal on a first side of a street;
wherein at least one of the second optical fibers and at least one conductor connected to the ONU serve subscriber premises on the first side of the street; and
wherein a buried composite cable carries at least one of the second optical fibers and at least one conductor connected to the ONU to a location on a second side of the street to serve subscriber premises on the second side of the street.

15. A system according to claim 1:
wherein the optical splitter interfaces a first optical fiber to a plurality of second optical fibers;
wherein one of the second optical fibers directly connects the optical splitter to the ONU;
wherein the optical splitter and the ONU are positioned at a pole; and
wherein at least one of the second optical fibers comprises an aerial fiber optic drop extending from the pole to an ONT at a subscriber premises.

16. A system according to claim 1:
wherein the optical splitter interfaces a first optical fiber to a plurality of second optical fibers;
wherein one of the second optical fibers directly connects the optical splitter to the ONU;
wherein the optical splitter and the ONU are positioned at a first pole; and
wherein an aerial composite cable carries at least one of the second optical fibers and at least one conductor from the ONU to a second pole; and
wherein the system further comprises:
a second optical splitter that is positioned at the second pole and that interfaces the at least one of the second optical fibers to at least one aerial fiber optic drop connected to an ONT at a subscriber premises; and
at least one aerial conductor drop extending from the second pole to the subscriber premises.

17. A system according to claim 1:
wherein the optical splitter interfaces a first optical fiber to a plurality of second optical fibers;
wherein one of the second optical fibers directly connects the optical splitter to the ONU;
wherein the optical splitter and the ONU are positioned at a pole on a first side of a street;
wherein at least one of the second optical fibers and at least one conductor connected to the ONU serve subscriber premises on the first side of the street;
wherein an aerial composite cable carries at least one of the second optical fibers and at least one conductor connected to the ONU to a second pole on the first side of the street; and
wherein the system further comprises:
a second optical splitter that is positioned at the second pole and that interfaces the at least one of the second optical fibers to aerial fiber optic drops to ONTs located at respective subscriber premises on the first side of the street and a second side of the street; and
a plurality of aerial conductor drops extending from the second pole to the subscriber premises on the first and second sides of the street.

18. A system according to claim 1, wherein the OLT is located at one of a central office (CO) or a remote terminal (RT).

19. A system according to claim 1, wherein the ONU is coupled to the OLT through a plurality of optical splitters.

20. A system according to claim 1:
wherein the optical splitter is configured to be coupled to a plurality of fiber optic drops that serve the plurality of subscriber premises;
wherein the ONU is configured to be connected to a plurality of conductor drops that serve the plurality of subscriber premises; and
wherein the OLT and the ONU are configured to provide a broadband service via the fiber optic drops and to provide a voice service and/or a data service via the conductor drops.

21. A telecommunications apparatus, comprising:
an optical splitter configured to interface a first fiber of a PON to a plurality of second fibers; and
an ONU co-located with the optical splitter, connected to one of the second optical fibers and configured to interface a plurality of conductive circuits to the one of the second fibers.

22. An apparatus according to claim 21, wherein the optical splitter and the ONU are configured to be co-located at one of a pole or a pedestal.

23. An apparatus according to claim 21, wherein the optical splitter and the ONU are respectively configured to receive the first fiber and a power conductor from a composite cable.

24. A method of providing communications services, the method comprising:
serving ONTs located at respective ones of a plurality of subscriber premises with an optical splitter of a hierarchical passive optical network (PON); and
providing communications via electrical media for the plurality of subscriber premises from an optical network unit (ONU) coupled to the PON.

25. A method according to claim 24, comprising directly subtending the ONU from the optical splitter.

26. A method according to claim 25, comprising co-locating the optical splitter and the ONU.

27. A method according to claim 26, wherein co-locating the optical splitter and the ONU comprises positioning the optical splitter and the ONU at the same pedestal or pole.

28. A method according to claim 24, further comprising powering the ONU from a power source at a location remote from the ONU.

29. A method according to claim 24, further comprising:
interfacing a first optical fiber to a plurality of second optical fibers at the optical splitter;
directly connecting one of the second optical fibers to the ONU; and
serving a subscriber premises of the plurality of subscriber premises with at least one of the second optical fibers.

30. A method according to claim 29, further comprising directly connecting at least one of the second optical fibers to an ONT at a subscriber premises.

31. A method according to claim 29, further comprising serving a second optical splitter with at least one of the second optical fibers.

32. A method according to claim 29, further comprising serving at second ONU that provides communications for a second plurality of subscriber premises with at least one of the second optical fibers.

33. A method according to claim 24, wherein the PON comprises one of an OLT or an HDT located at one of a central office (CO) or a remote terminal (RT).

34. A method according to claim 24, wherein the ONU is coupled to one of an OLT or an HDT of the PON through a plurality of optical splitters.

35. A method according to claim 24:
wherein the optical splitter is configured to be coupled to a plurality of fiber optic drops to that serve the plurality of subscriber premises;
wherein the ONU is configured to be connected to a plurality of conductor drops that serve the plurality of subscriber premises; and
wherein the method further comprises:
providing a broadband service via the fiber optic drops; and
providing a voice service and/or a data service via the conductor drops.
